(19) United States
(12) Patent Application Publication
(10) Pub. No.: US 2023/0193536 A1
(43) Pub. Date: Jun. 22, 2023

(54) FIBER FILAMENT NON-WOVEN FABRIC

(71) Applicants: Enhao LUO, Surrey (CA); Annie LUO, Surrey (CA); Dakai LUO, Surrey (CA)

(72) Inventors: Enhao Luo, Surrey (CA); Dakai Luo, Surrey (CA); Annie Luo, Surrey (CA)

(21) Appl. No.: 17/996,344

(22) PCT Filed: Feb. 16, 2021
(86) PCT No.: PCT/CA2021/000033

§ 371 Date: Oct. 16, 2022

(30) Foreign Application Priority Data
May 1, 2020 (CA) 3, 080, 018

(51) Int. Cl. D04H 3/02; D04H 3/016; D04H 3/115; B01D 39/16

(52) U.S. Cl. CPC D04H 3/02; D04H 3/016; D04H 3/115; B01D 39/163

(57) ABSTRACT

The invention discloses a fiber filament non-woven fabric with a small pore size and a large porosity, which adopts an island type ultra-fine fiber single filament, which is juxtaposed into an unidirectional silk layer several times, and a thin strip-shaped liquid is applied laterally on the unidirectional silk layer. The resin adhesive liquid bonds and fixes all the silk layers into a unidirectional non-woven fabric fixed in a grid segment. The unidirectional non-woven fabric is covered with meltblown non-woven fabric on one or both sides to make a filter material that can 100% filter viruses, bacteria, and micro-particles smaller than PM2.5. It can also be used for a wider range of filter materials, thermal insulation materials, oil absorption materials, battery separator materials, medical and health materials, environmental protection materials, clothing materials, wiping materials.

### TECHNICAL FIELD

The invention relates to an ultra-fine fiber filament non-woven fabric, especially a grid-type non-woven fabric for filtering viruses

### BACKGROUND

The existing medical mask material, which is the core material used to filter viruses, melt-blown microfiber electrostatic non-woven fabric, KN95 standard is able to filter more than 95% of fine dust, bacteria and viruses. “Melt-blown electrostatic cloth” mainly relies on static electricity to absorb viruses, but the moist gas exhaled in the mouth will reduce static electricity within a few minutes, making it easy for people to be infected and medical personnel to be infected. Due to the uneven pore size of melt-blown non-woven fabrics, for example, the general diameter of coronavirus is between 60-120 nanometers nm, and some pore diameters of melt-blown non-woven fabrics are more than several times, such as CN20121000049042, with the name: a new material mask, In order to solve the problem that the fiber gap in the non-woven mask is too large to block PM2.5 particles, the diameter of each monofilament is 0.15 dtex, each monofilament has 16 uniform chrysanthemum bifurcations, and the high-purity water needle. It is formed by entanglement by blasting, and the fiber gap of the fabric is less than one micrometer μm, but the gap is less than 1 μm or it is several times larger than the virus.

### TECHNICAL CONTENT

In order to overcome the problems in the prior art that the melt-blown fiber nonwoven fabric has a large pore size and the static electricity will be weakened by the humid charge after human use, the continuous fiber filament made by the island blend spinning method can have a diameter of 0.001 per filament dtex, each monofilament contains 37 ultra-fine monofilaments, the diameter of each ultra-fine monofilament is at least 0.0001 dtex, where the sea component dissolves to produce a very small diameter gap, the monofilaments are stacked side by side and stacked into unidirectional filaments In the layer, there is also a very small gap at the contact of the parallel single wires. The above gaps are smaller than the diameter of the virus, preventing all viruses from passing through.

The technical solution adopted by the present invention to solve its technical problems is a fiber filament non-woven fabric with a small pore size and a large porosity. A fiber filament non-woven fabric with large aperture and porosity, using ultra-fine fiber filaments, including island-in-the-sea fibers, composite fibers, characterized in that the ultra-fine fiber single filaments are juxtaposed, stacked and stacked several times It is formed into a unidirectional silk layer, which is flattened by a roller, and is segmented at intervals on the cross section of the longitudinal silk layer, including the application of thin strips of liquid adhesive material, soaked silk layer, bonding and fixing, including 770 temperature welding Fixed, grid-type segmented fixed unidirectional silk layer. To strengthen the fixed unidirectional silk layer, a layer of meltblown cloth, including fiber fabric cloth, can also be stacked on one or both sides of the fixed unidirectional silk layer The method includes superimposing fixed unidirectional filament layers in different directions on a fixed unidirectional layer, and then superimposing the above-mentioned reinforcing layer to form a composite nonwoven fabric with small pore size, large porosity and uniform porosity.

The above-mentioned parallel arrangement scheme is to combine island-shaped single ultra-fine fiber filaments containing several ultra-fine fibers, or composite single filaments containing several fine fibers, after juxtaposing several filaments into small tows Weaken the twist and wind it into a tube, then unwind the small tows wound by several tubes and juxtapose into a large tow, and weaken the wind and wind into a tube, including repeating the above method and repeating one or more times to juxtapose a larger tow After that, each large tow cylinder is pulled back and parallel to form the density required by the thickness and width of the established unidirectional filament layer.

The above-mentioned parallel arrangement scheme includes sea island-shaped single ultra-fine fiber filaments containing several ultra-fine fibers, and composite single filaments containing several fine fibers, which are juxtaposed into small tows. Sizing and winding into small tow bundles, and then juxtaposing the bundles into large tow belts, sizing and winding into large tow belts, and then juxtaposing several belts into the established unidirectional filament layer thickness and width requirements Density, desizing, cleaning and drying.

A layer of melt-blown nonwoven fabric is superimposed on one or both sides of the above-mentioned fixed unidirectional silk layer, which also includes the superposition of melt-blown non-woven fabric on one or both sides of the unidirectional fixed silk layer superimposed into a bidirectional, multiaxial composite nonwoven fabric The woven fabric serves as a reinforcement layer.

The above-mentioned composite non-woven fabrics are mainly used for filter materials, thermal insulation materials, oil-absorbing materials, battery separator materials, medical and sanitary materials, environmental protection materials, clothing materials, and wiping materials.

The beneficial effect of the present invention is that the diameter of the single filament made by the sea island blend spinning method is at least 0.001 dtex. Each single filament contains several ultra-fine fiber filaments with irregular diamond-shaped edges. The minimum diameter is 0.0001 dtex. After chemically dissolving the sea component, the gap formed is smaller than the virus diameter and can pass through the gas. The gap formed by the contact of the parallel single wires is smaller than the virus diameter and can pass through the gas. The above-mentioned gaps are relatively uniform, through several single filaments are juxtaposed, superimposed and piled up to form a unidirectional filament layer with tightly arranged, set thickness and width. Then, the longitudinal unidirectional silk layer is coated with a thin strip of liquid resin adhesive in the horizontal direction, which is saturated with the silk layer, the fixed silk layer, and the grid-type ultrafine fiber filament unidirectional nonwoven fabric, which has a small pore size, Large porosity, uniform porosity, gas, 100% blocking the passage of viruses, bacteria can also be blocked, can also block the passage of very small diameter micro particles. For example, the application and core materials of medical masks can ensure that people are not passed on and people are not infected. After the surface disinfection is relatively easy, it can be reused to reduce the amount of reserves. The existing technology can be used for industrial production and commercial production. It can be extended and expanded, and its performance is more superior. Battery isolation materials, medical and health materials, environmental protection materials, clothing materials, wiping materials.

### DRAWING DESCRIPTION

The present invention will be further described below with reference to the drawings and embodiments.

FIG. 1 is a schematic diagram of a grid-type unidirectional filament layer filament nonwoven fabric of the present invention:

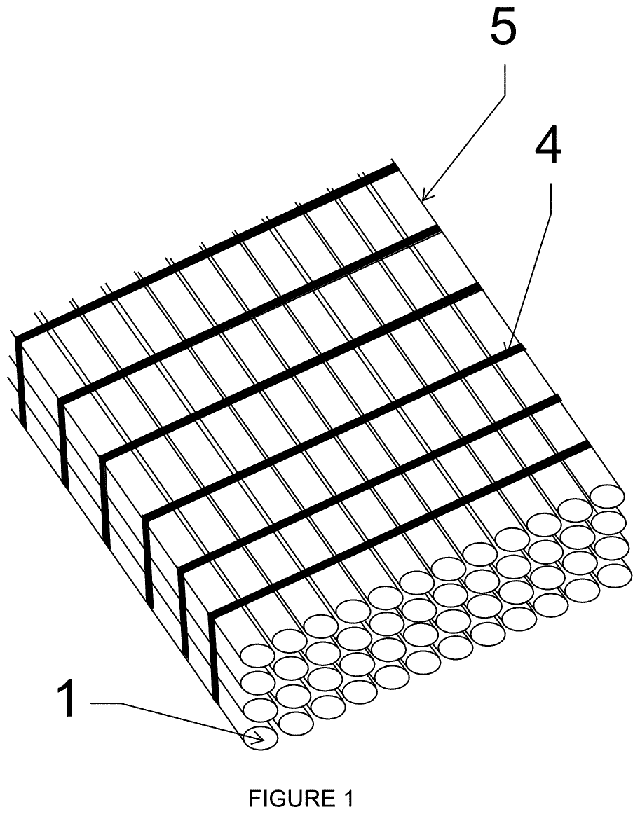

FIG. 2 is a cross-sectional view of a single island-in-the-sea microfiber after dissolution:

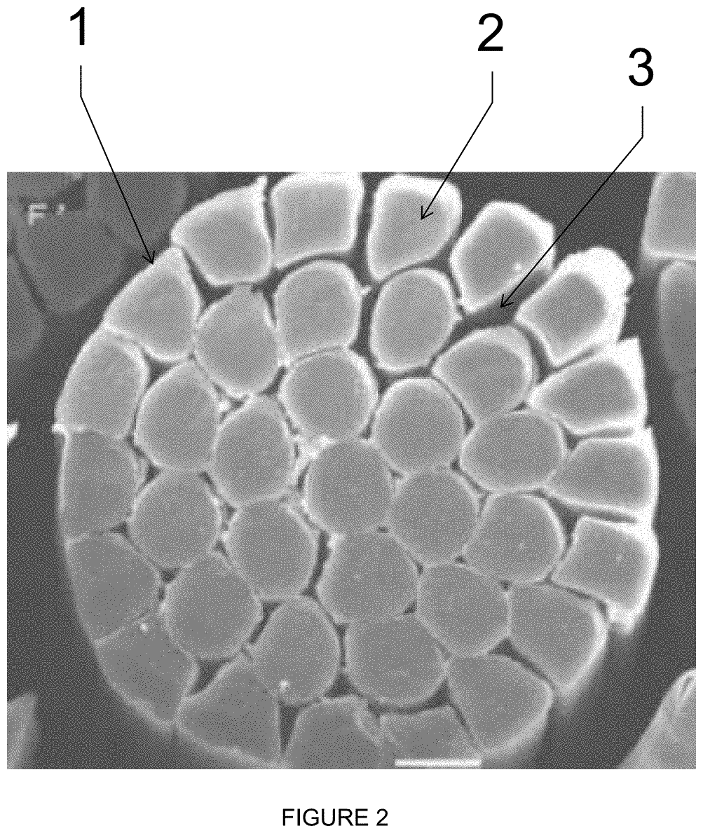

In the picture 1. microfiber single filament, 2. microfiber filament, 3. gap, 4. bonding material, 5. unidirectional filament layer.

### DETAILED DESCRIPTION

### Example 1

The fiber filament non-woven fabric with small pore size and large porosity adopts polyester (polyester fiber Polyester Fibers, English abbreviation PET) sea island type blended spinning method to produce ultrafine fiber single filament 1, each ultrafine fiber single filament Contains several ultra-fine fiber filaments 2, the island part remaining after the sea component is dissolved by a chemical method to form a very small aperture gap 3. Combine several ultra-fine fiber single filaments 1 side by side into a small tow, small The parallel ultra-fine fiber filaments in the tow are close to each other, and a gap 3 is formed at the contact. The ultra-fine fiber filaments 2 and the ultra-fine fiber filaments in parallel contact are extremely small Aperture gap 3. The gap 3 is smaller than the virus diameter, including the corona virus diameter. For easy winding of the parallel small tows, it is necessary to weaken the rolls and form a bobbin on the winding shaft. After that, several small tow rolls are retracted and juxtaposed into large tows. The large tow needs to be weakened and wound into a tube on the shaft. In order to reduce the number of parallel rows each time, the large tow bundles can be paralleled multiple times, and then several large tow cylinders can be retracted and exemplified as a unidirectional filament layer 5 with a set thickness and width. The set tension is applied at both ends in the longitudinal direction of the unidirectional silk layer 5 to keep the parallel wires in the silk layer straight. Adhesive material 4. The bonding material 4 should penetrate the silk layer and fix all the silk in the silk layer to form a non-woven fabric with a grid-type unidirectional silk layer 5 fixed in sections. A unidirectional silk layer 5 nonwoven fabric can be compounded with a reinforcing layer of meltblown nonwoven fabric to form a single-sided composite nonwoven fabric. It is also possible to compound a layer of melt-blown nonwoven fabric on both sides of the unidirectional silk layer nonwoven fabric to form a double-sided composite nonwoven fabric, which can be bonded.

### Example 2

The grid-type unidirectional filament layer 5 non-woven fabric fixed in sections can superimpose the same unidirectional filament layer 5 non-woven fabric into two directions. 0°+90 ° bidirectional non-woven fabric can also be stacked into multi-axial, 0°+90°+45°+−45° multi-axial non-woven fabric. The superimposed layer can be bonded and bonded. It can also be covered with meltblown nonwoven fabric or woven fabric on one or both sides of the bidirectional, multiaxial nonwoven fabric to form a composite nonwoven fabric.

### Example 3

In the process of juxtaposition of unidirectional filament layers, several ultra-fine fiber single filaments 1 can be juxtaposed. After sizing, they are wound into a tube to form a small tow tube. Later, several small tows are juxtaposed and sizing to form a large tow. Wind up into a large tow tube, parallel the large tow tube to desizing, clean and dry. The unidirectional filament layer 5 is formed.

### Example 4

The unidirectional wire layer 5 can also be fixed by heating and welding, and a thin strip is welded on the cross section of the unidirectional wire layer 5, a thin strip is welded at a distance, and the circular unidirectional wire layer 5 is repeatedly circulated into a nonwoven The same welding method can be used for cloth, superimposed layer and covering layer.

1. A fiber filament non-woven fabric with large aperture and porosity, using ultra-fine fiber filaments, including island fibers and composite fibers. It is characterized by the use of ultra-fine fiber single filaments (1), juxtaposed several times, stacked into an unidirectional filament layer (5), flattened by roller pressing, and there are gaps in the cross section of the longitudinal filament layer (3) To carry out segmentation, including applying thin strips of liquid adhesive material (4), impregnating the silk layer, bonding and fixing, including heating and welding, fixing the unidirectional silk layer (5) into a grid-type segmentation, for Strengthen the fixed unidirectional silk layer (5), you can also superimpose a layer of meltblown cloth on one or both sides of the fixed unidirectional silk layer (5), including fiber fabric cloth, and also include the fixed unidirectional layer (5). The fixed unidirectional silk layer (5) in different directions is superimposed, and then the above reinforcement layer is superimposed to form a composite nonwoven fabric with small pore size, large porosity and uniform porosity.

2. According to claim 1, a fiber filament nonwoven fabric with large pore size and porosity, and characterized in that the multiple parallel arrangement is an island type single wire containing several ultra-fine fibers Ultra-fine fiber filaments (2), including composite single filaments containing several fine fibers, several juxtaposed into small tows, then weakened and wound into a tube, and then the small tube is wound tows are untwisted and juxtaposed into large tows, and the weaken twists are wound into drums, including repeating one or more times in the above manner and juxtaposed into larger tow drums, after which each big tow drum is untwisted and paralleled into the established density required for the thickness and width of the unidirectional silk layer (5).

3. According to claim 1, the fiber filament non-woven fabric with large pore diameter and porosity, and wherein the parallel arrangement of several times includes the island-in-sea single ultra-fine fibers containing several ultra-fine fibers Filament (2), or a composite single filament containing several fine fibers, several juxtaposed into small tows, sizing and winding into small tow tubes, and then juxtaposing the tube into large tow belts, sizing It is wound into a large tow belt drum, and several belt drums are juxtaposed into the density required by the thickness and width of the established unidirectional filament layer (5) for desizing, cleaning and drying.

4. According to claim 1, a fiber filament nonwoven fabric with a large pore size and a large porosity and characterized in that a layer of melt-blown nonwoven fabric is superimposed on one or both sides of the fixed unidirectional filament layer (5). It also includes superimposing the melt-blown non-woven fabric on one or both sides of the unidirectional fixed filament layer into a bi-directional, multi-axial composite non-woven fabric as a reinforcement layer.

5. According to claim 1, a fiber filament non-woven fabric with a large pore size and porosity, and wherein the composite non-woven fabric is mainly used for filter materials, thermal insulation materials, oil-absorbing materials, battery separator materials, medical Sanitary materials, environmental protection materials, clothing materials, wiping materials.

6. According to claim 1, the change of the technical solution principle and scope of the fiber filament nonwoven fabric with small pore size and large porosity according to claims 1 to 6 shall fall within the scope of the claims of the present invention.
